(19) United States
(12) Patent Application Publication
(10) Pub. No.: US 2009/0008046 A1
(43) Pub. Date: Jan. 8, 2009

(54) Device for Operating a Screen, Such as a Window Covering

(76) Inventor: Christiaan Johannes Roetgering, Enter (NL)

Correspondence Address: JENSEN + PUNTIGAM, P.S., 2033 6th Ave, Suite 1020, SEATTLE, WA, 98121, US

(21) Appl. No.: 11/817,681

(22) PCT Filed: Mar. 2, 2006
(86) PCT No.: PCT/NL2006/000108

§ 371 Date: May 5, 2008

(30) Foreign Application Priority Data
Mar. 3, 2005 (NL) 1028450

(51) Int. Cl. E06B 9/56

(52) U.S. Cl. 160/321

(57) ABSTRACT

A device for operating a screen, such as a window covering, which has at least two mutually independent degrees of freedom, has a central drive which can be switched between the degrees of freedom by means of switching means, which switching means can be operated by means of operating means. The switching means have a stable position for each degree of freedom.

The invention relates to a device for operating a screen, such as a window covering, which has at least two mutually independent degrees of freedom, which device has a central drive which can be switched between the degrees of freedom by means of switching means, which switching means can be operated by means of operating means.

Such a device is known. In a known device the operating means comprise a cord, a bead chain or the like which, for instance in the manner of an endless loop, is trained around a drive wheel. The central drive is energized by pulling on the cord on the one or on the other side, whereby the movement in the relevant degree of freedom can take place in the one or the other direction. An example of a known device is intended for operating a blind comprising vertical slats. This known device comprises: a rail along which are displaceable runners which carry the respective slats by means of carriages; first operating means for displacing the runners along the rail, optionally in the one or the other direction, between two extreme positions, i.e. a grouped first position in which the runners are all grouped at one end of the rail, and a distributed second position in which the runners are distributed evenly over the effective length of the rail; which operating means comprise an endless translation chain which is movable along the rail and which is trained around two rollers arranged on the rail, at least one of which rollers is drivable by means of a first drive and in turn drives the translation chain in translating manner, which translation chain is connected to the one outermost runner while the other outermost runner is connected substantially non-movably to the rail, and wherein each runner is coupled by a flexible pull element to each of its adjacent runners; and second operating means with a second drive for rotating around their vertical rotation axis, in any longitudinal position of the runners, carriages connected rotatably to the runners for carrying the slats.

This known device thus has two degrees of freedom, i.e. a degree of freedom of translation between the grouped first position and the distributed second position of the runners, and a degree of freedom of rotation for rotating around their vertical rotation axis the carriages connected rotatably to the runners.

Known and generally usual is the use of individual operating means for each of the said degrees of freedom. Also known however is the use of combined first and second operating means for operating the switching means. In a known device the operating means comprise a shaft which is rotatingly drivable by means of a rotation handle and which is connected to the central drive for energizing purposes. By pressing upward or, depending on the embodiment, pulling downward the relevant shaft via the operating handle, the other degree of freedom can be selected temporarily counter to the action of a resetting spring. This construction has the drawback that it must always be operated with two hands and is not very reliable. It is generally perceived as impractical.

When only one control cord or driving motor is used, use is also made in the prior art of a differential construction which functions such that a rotation of the carriages is only possible at the ends of the translation displacement along the rail.

It is also known to make use of a separate motor for each of the degrees of freedom. This is a solution which can be realized in technically simple manner. It does however have the drawback that the device is expensive.

For the described prior art reference is made to U.S. Pat. No. 3,455,364, NL-A-7310605, GB-A-1 159 635, DE-A-2344288, DE-A-2737416, WO-A 93/24726, EP-A-0 012 263, U.S. Pat. No. 4,047,554, EP-A-0 467 627, NL-A-7613555, U.S. Pat. No. 5,845,695, DE-U-9406838, EP-A-0 672 816.

In the light of the foregoing, the invention provides a device of the type stated in the preamble which has the feature that the switching means have a stable position for each degree of freedom.

A practical embodiment is one in which the switching means are adapted to switch the central drive in cyclical manner between the degrees of freedom. In the case of only two degrees of freedom, the switching means are bistable and, when the operating means are operated, switching takes place back and forth between the one degree of freedom and the other.

A specific embodiment has the special feature that the operating means are also adapted to energize the central drive. It is thus possible to envisage an embodiment in which a per se known control cord for performing a changeover from the one degree of freedom to the other is subjected for a short time to a movement other than the usual pulling movement on one of the two parts, i.e. for instance a lateral displacement with a certain pulling force, a forward displacement with a certain pulling force, or exerting a pulling force simultaneously on the front side and the rear side of the cord loop. It is hereby possible with suitable provisions to achieve said changeover between the degrees of freedom. As will be apparent, this changeover is independent of the position in the other degree of freedom or degrees of freedom. The movement of the degree of freedom for instance in the one or the other direction does not therefore have to be fully completed before the changeover can take place.

According to yet another aspect of the invention, the device has the special feature that the central drive comprises a transmission with one input shaft and a number of output shafts, one for each degree of freedom.

According to yet another aspect, the device has the special feature that the input shaft is coupled to the operating means driving the input shaft rotatingly in optionally the one or other direction, such as a control cord which can be operated by hand, a rotation handle which can be operated by hand, or an electric motor.

A practical embodiment has the feature that the switching means comprise a switching member which can be operated by the operating means and which, when operated, uncouples the input shaft from the output shaft to which it is at that moment coupled, and subsequently couples it to another output shaft. The switching member can for instance comprise a movably disposed bracket with a guide eye which, when displaced, causes switching of the transmission, wherein a bead chain, a cord or the like extends through the relevant eye. By displacing for instance the bead chain or the cord laterally while exerting some pulling force it is possible to achieve that the bracket brings about changeover from the one degree of freedom to another.

In a determined embodiment the device is designed such that the screen has two degrees of freedom, for instance comprises a sunblind with vertical or horizontal slats. As already described above, the translation can be the one degree of freedom and the rotation can be the other degree of freedom.

In yet another embodiment the device has the feature that the window covering comprises at least two sun blinds, each having at least one degree of freedom, for instance a roller blind and/or a pleated blind, and/or a folding blind. In this embodiment the two or more part-screens can be displaced independently of each other by the operating means.

A practical embodiment has the special feature that the device comprises a housing in which the central drive and the switching means are accommodated.

An embodiment is however recommended in which the device comprises a housing to which a second housing is releasably coupled, in which second housing the central housing and the switching means are accommodated.

For smooth switching between the degrees of freedom the device can have the special feature that the switching means comprise rotatable pairs of components which are placed in mutual engagement or taken out of engagement during switching between the degrees of freedom, for instance toothed wheels which are axially displaceable relative to each other, wherein the end edges first making contact with each other of at least one of a pair of these components have a chamfered, for instance non-round form, and thus have positioning edges.

It is noted that combinations of the described aspects are also possible within the scope of the invention.

The invention will now be elucidated on the basis of the accompanying drawings of several exemplary embodiments, to which the invention is not limited. In the drawings:

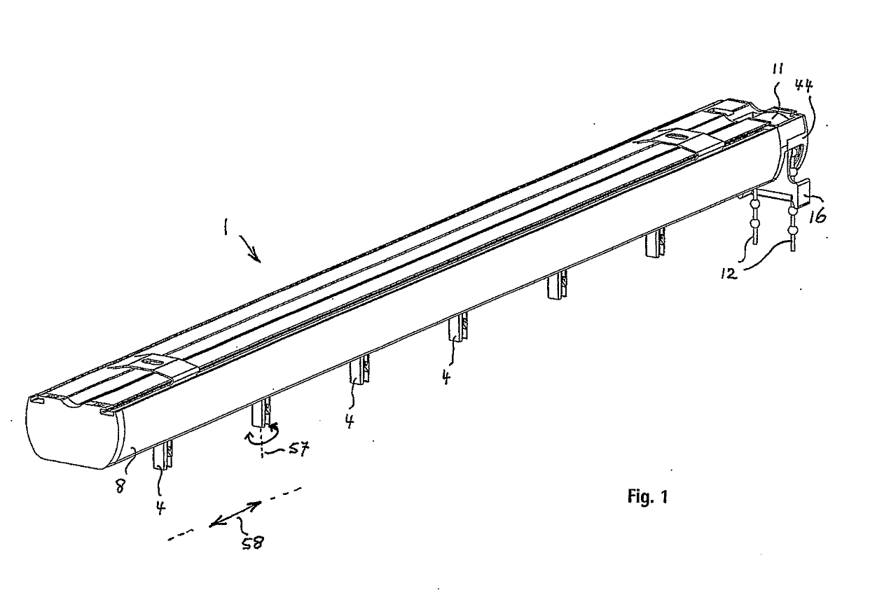

FIG. 1 is a perspective view from the left-hand side of a device according to the invention in assembled, closed state;

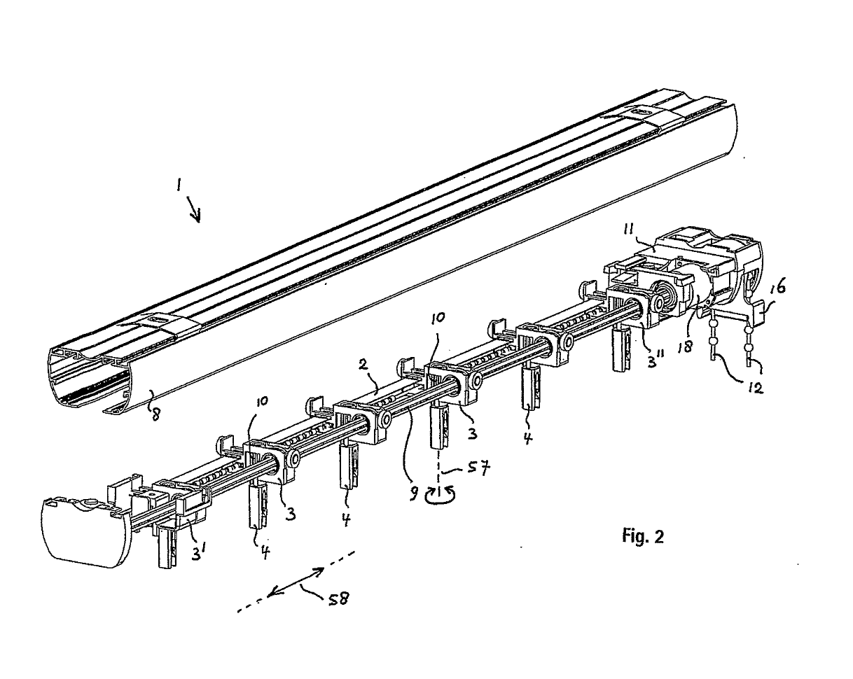

FIG. 2 is a perspective view corresponding with FIG. 1 of the device, wherein the elongate housing is drawn at a distance such that the internal mechanism of the device is visible;

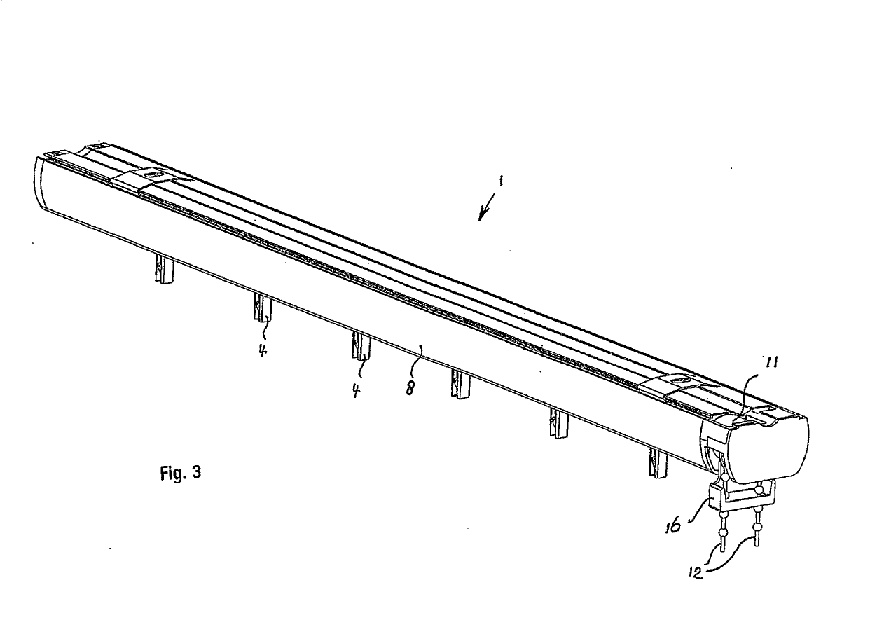

FIG. 3 is a perspective view from the right-hand side of the device;

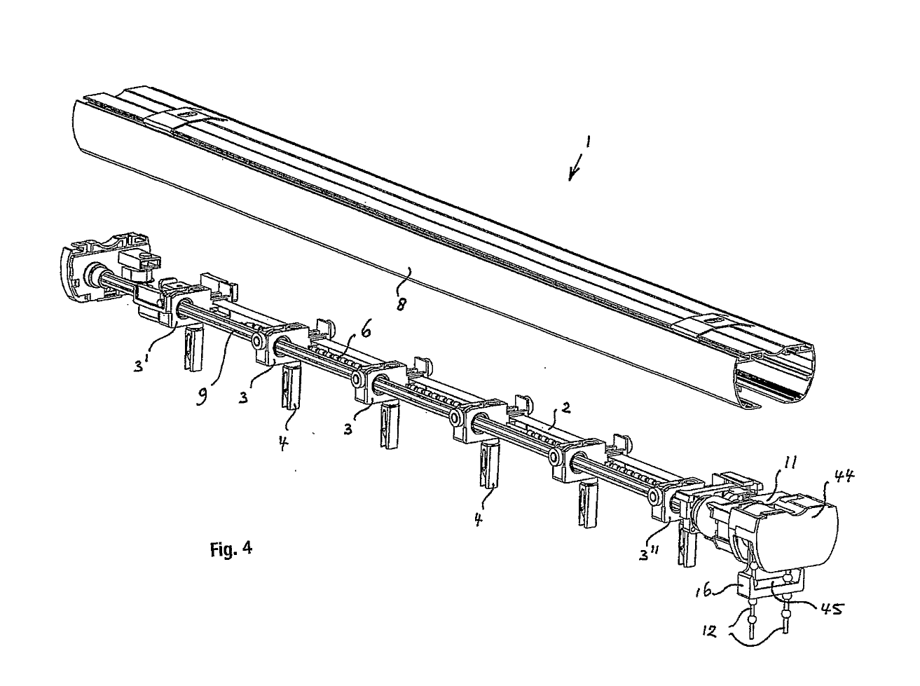

FIG. 4 is a view corresponding with FIG. 3 of the situation shown in FIG. 2;

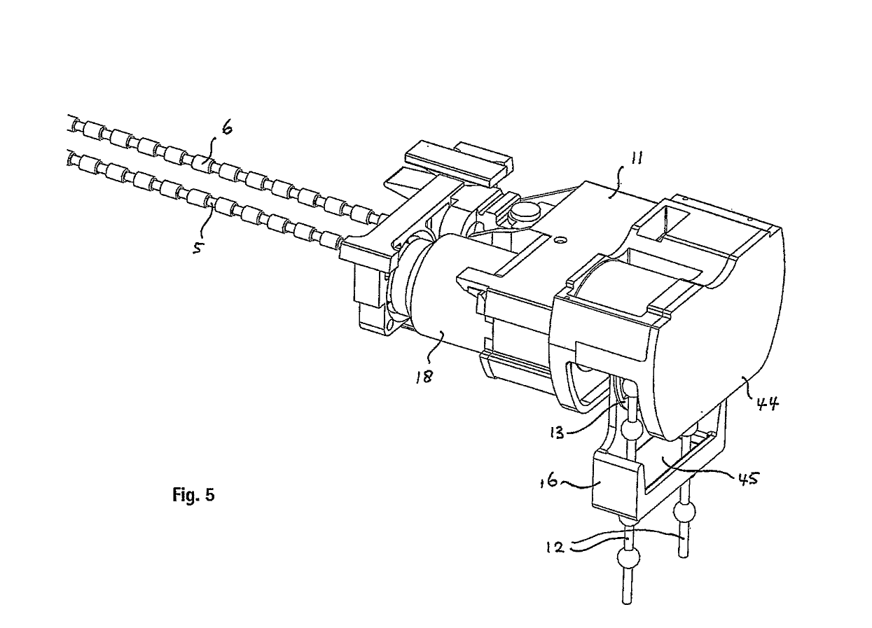

FIG. 5 is a perspective view from the right-hand side of the central control and the operating means in closed position;

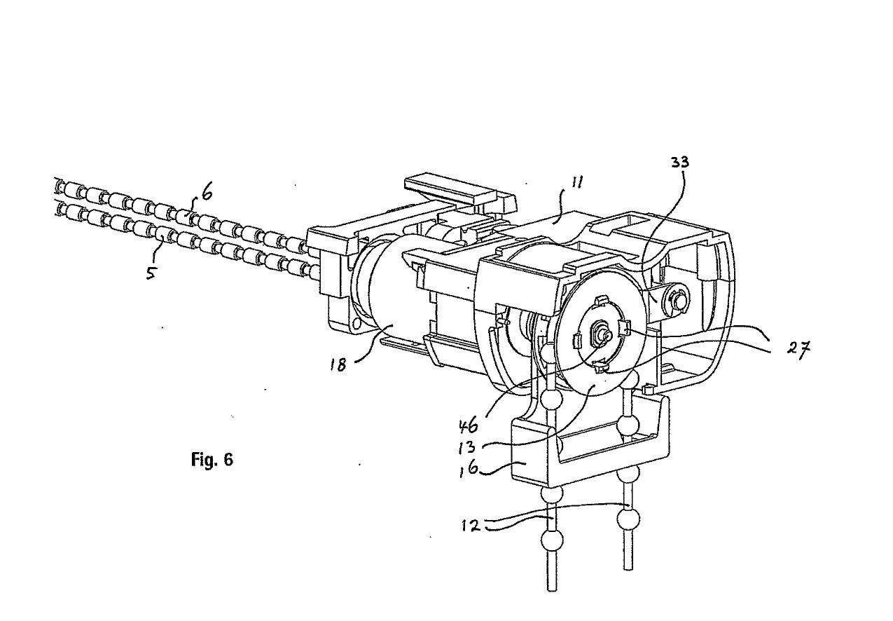

FIG. 6 is a view corresponding with FIG. 5, wherein a part of the covering is removed whereby the internal mechanism is visible;

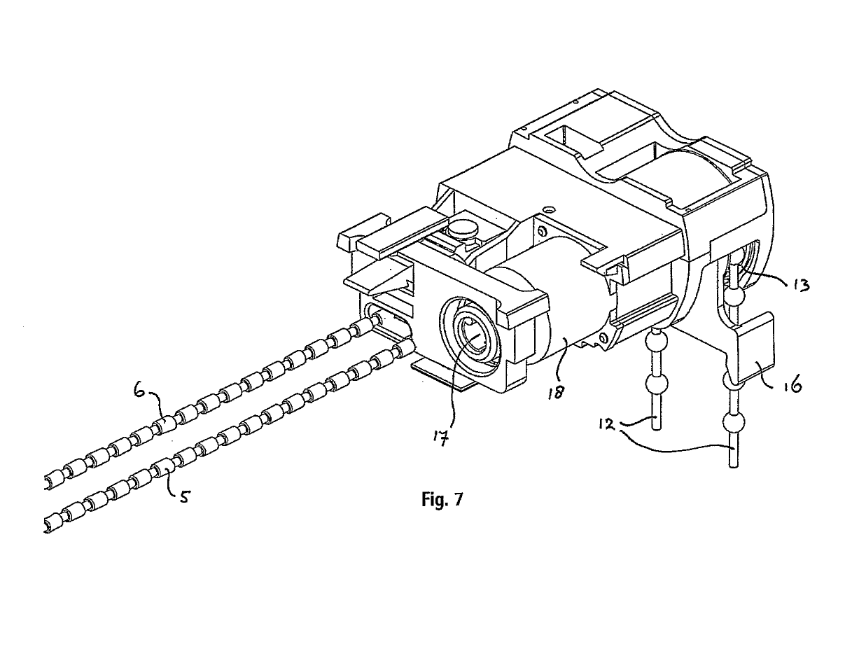

FIG. 7 is a perspective view from the left-hand side corresponding with FIG. 5;

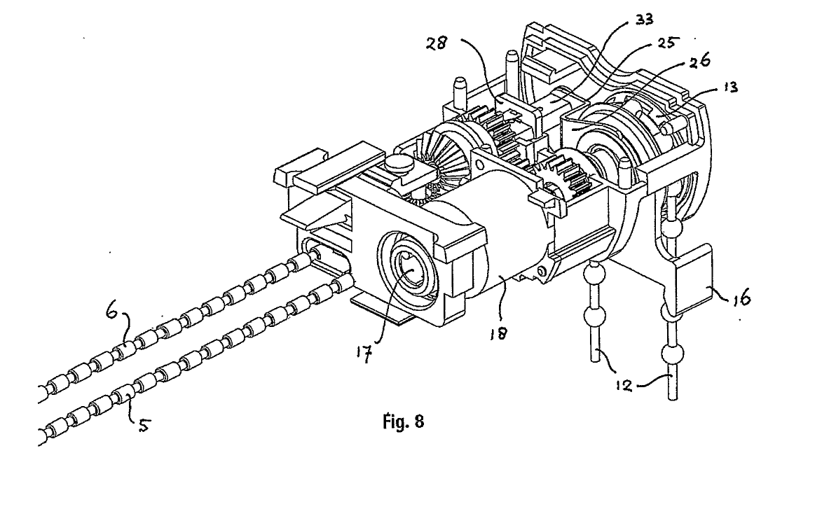

FIG. 8 is a view corresponding with FIG. 7, wherein a part of the internal mechanism is visible;

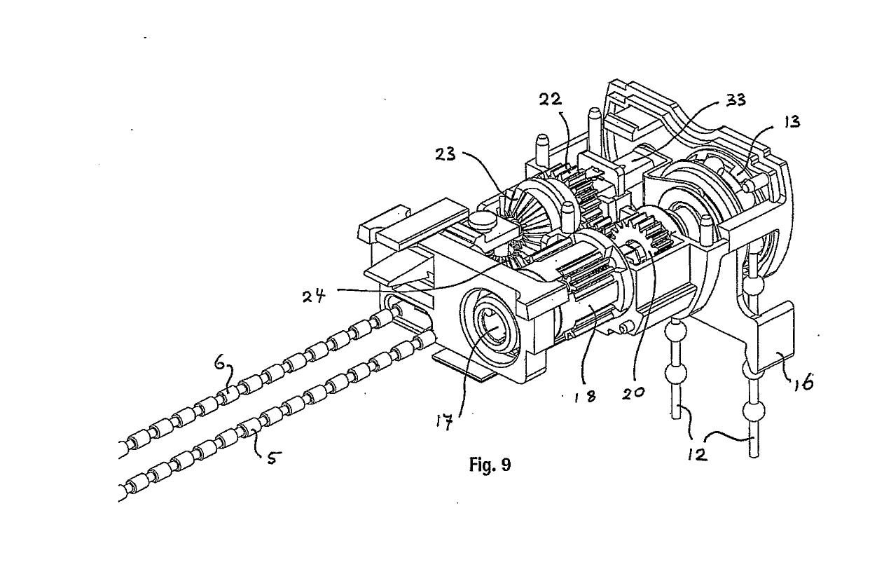

FIG. 9 is a view corresponding with FIG. 8, wherein substantially the whole internal mechanism is visible;

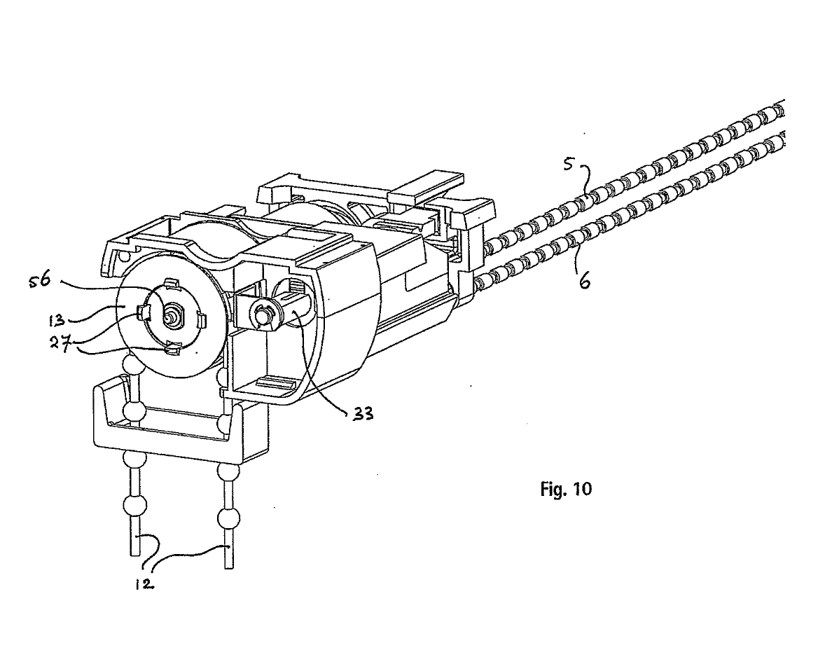

FIG. 10 is a perspective view, from behind and from the right, of the device as shown in FIG. 7;

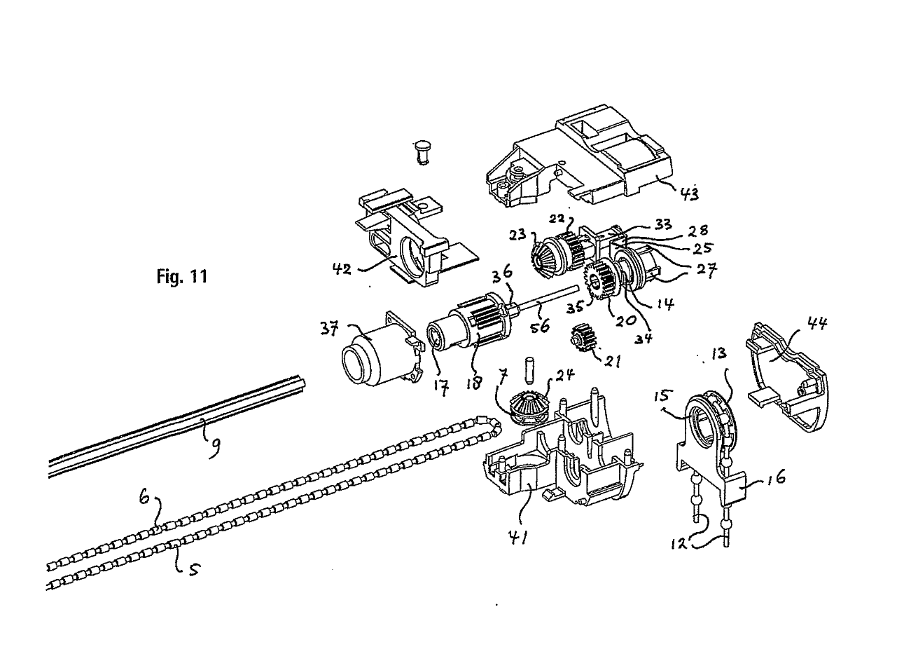

FIG. 11 is an exploded view of the device according to FIGS. 7, 8, 9 and 10;

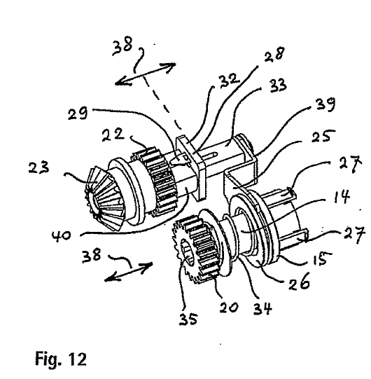

FIG. 12 is a perspective view of a part of the gear transmission;

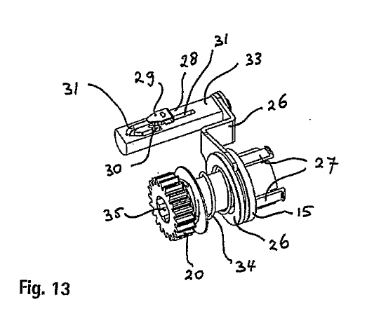

FIG. 13 shows a part of the transmission of FIG. 12;

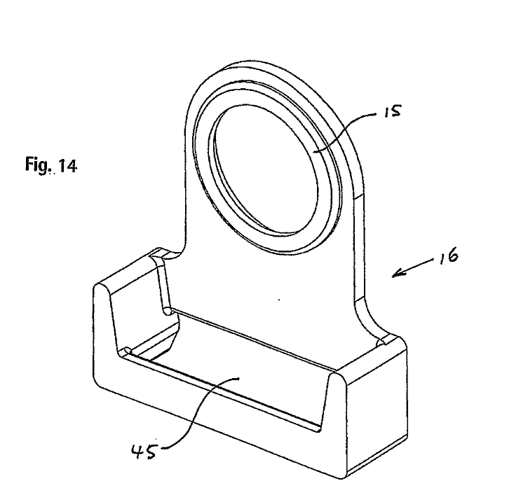

FIG. 14 shows the switching bracket with a guide eye for switching between the two degrees of freedom by means of the bead chain; and

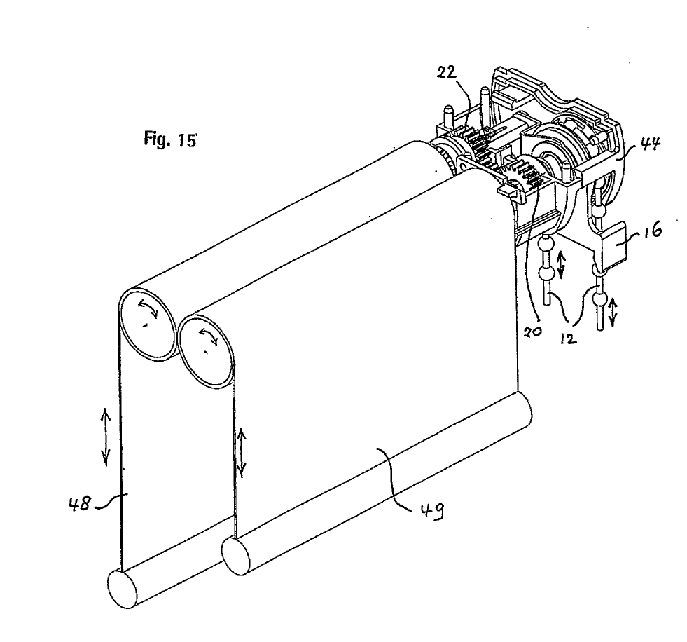

FIG. 15 is a perspective view of a variant with the cover removed.

FIGS. 1, 2, 3 and 4 show an exemplary embodiment of a device 1 according to the invention. Device 1 is intended for operating a sunblind (not shown) comprising vertical slats. Device 1 comprises a rail 2 along which runners 3 are displaceable, which runners 3 can carry the respective slats by means of carriages 4 rotatable around their respective vertical axes 57.

First operating means to be described herein below serve to displace the runners along rail 2 optionally in the one or the other direction 58 between two extreme positions, i.e. a grouped first position in which runners 3 are all grouped at one end of rail 2, and a distributed second position as shown in FIGS. 1, 2, 3 and 4 in which runners 3 are distributed regularly over the effective length of rail 2.

Said first operating means comprise an endless translation bead chain which is movable along rail 2 and of which the two straight, mutually parallel parts are designated with reference numerals 5 and 6. (See also FIGS. 5, 6, 7, 8, 9, 10, 11). The translation chain 5, 6 is trained around two rollers which are disposed fixedly relative to the rail and one of which, designated with reference numeral 7, is drawn in FIG. 11. Below will be described the manner in which this roller 7 forms part of central drive 11 and thus serves to displace the translation chain 5, 6 in longitudinal direction.

On the other side of housing 8 is situated a free-turning reversing roller. This is not drawn in the figures. The translation chain 5, 6 is connected to the runner which is furthest to the left in FIGS. 1, 2, 3 and 4 and which for the sake of clarity is designated in FIGS. 2 and 4 with reference numeral 3′. The other runner furthest to the right is designated 3″ in FIGS. 2 and 4. This runner 3″ can be connected substantially non-movably to rail 2.

When runner 3′ is translated to the left, the following adjacent runner 3 is hereby co-displaced. This latter in turn co-displaces its following adjacent runner until eventually the distributed position shown in FIGS. 1, 2, 3 and 4 is obtained.

It will be apparent that the described first operating means serve to displace or translate runners 3 in longitudinal direction. This is a first degree of freedom.

A second degree of freedom is rotation of carriages 4 around their vertical axis. For this purpose device 1 comprises second operating means for rotation around their vertical rotation axis, in any random longitudinal position of runners 3, of the carriages 4 which are connected rotatably to runners 3 and which carry the slats (not drawn). Said rotation is effected from the central drive 11 to be described below, of which a non-round output socket 17 can be coupled to a complementary non-round shaft 9, which extends parallel to rail 2, has a prismatic form, i.e. everywhere has the same cross-section, and also serves to support runners 3 together with rail 2. By rotating the non-round shaft 9 in any random longitudinal position of a runner 3, a rotation of carriages 4 takes place by means of a right-angled transmission 10 which is not shown in detail.

Runners 3 are slidable along shaft 9. For a desired rotation of carriages 4 it is therefore not important at which longitudinal position a runner 3 is situated. Carriages 4 can be rotated together as soon as changeover to the degree of freedom of rotation has taken place.

In the drawn embodiment the central drive 11 is energized manually by means of a bead chain 12 which in the manner shown in FIG. 11 engages in a toothed wheel 13 connected to input shaft 14 of central drive 11. Toothed wheel 13 is supported rotatably by a ring 15 which forms part of an operating bracket 16. A translation or rotation of carriages 4 can be effected by pulling on one of the two parts of chain 12, depending on the chosen degree of freedom. By displacing the bead chain 12 laterally with a light pulling force on both active parts counter to the action of a resetting spring 34, the bracket 16, through the eye 45 of which chain 12 extends, is co-displaced whereby central drive 11 switches from the one degree of freedom to the other.

Reference is now made to FIGS. 5, 6, 7, 8, 9, 10, 11, 12, 13 and 14, in which special features of the central transmission 11, the switching means and the operating means are drawn in different ways. Runners 3 and carriages 4 are not drawn here.

The non-round shaft 9 is inserted in a non-round output socket 17 of a reducing planetary system 18 with a complementary non-round input shaft 36 which fits into a complementary non-round socket 35 in a toothed wheel 20, as will be described below and from which extends a positioning shaft 56.

Essential for the invention is that it is possible to switch between the translation of translation chain 5, 6 and the rotation of the non-round shaft 9. With the rotation of toothed wheel 13 there also takes place via shaft 14 rotation of a toothed wheel 20 which, via a toothed wheel 21, can set a toothed wheel 22 into rotation which, via a right-angled transmission with bevel wheels 23, 24 (fixedly connected to toothed wheel 7), can in turn cause translation of translation chain 5, 6 when the degree of freedom of translation is chosen. When the degree of freedom of rotation is chosen, the non-round shaft 9 is rotated via planetary system 19. Both degrees of freedom are mutually exclusive. This means that either the one degree of freedom or the other degree of freedom is active.

FIG. 11 shows the diverse components. Switching component 25 is important for the switching between the two degrees of freedom. This is drawn separately in FIG. 12.

FIG. 13 shows carriage 26 of, among other parts, toothed wheel 20 which is coupled directly in releasable manner via snap lips 27 to the driving toothed wheel 13.

The changeover between the degree of freedom of translation and the degree of freedom of rotation takes place by laterally displacing the operating bracket 16 which operates a switch mechanism 28, the action of which is comparable to that of the click system of a ballpoint pen. Use is made of a resilient tongue 29 which bears on its underside a pin 30. Under the influence of the resilience of the tongue this pin presses in a groove 31 having the form of a closed contour. FIG. 13 shows that groove 31 has a tapering form on its left-hand side such that pin 30, pressing against it, can take up a stable position. Situated on the other side of the contour-shaped groove 31 is a tapering recess which is likewise directed not outward but inward and where pin 30 can likewise take up a stable position in pressing manner. The pin, and thereby the resilient tongue 29 and thus also flange 32 (see FIG. 12), therefore have two stable positions relative to groove 31. In known manner the pin is always guided in one direction, i.e. because on either side of the said extremes the groove has an incline relative to the outer surface of block 33, only movement in one peripheral direction is possible from said stable positions.

Toothed wheels 21 and 22 remain in fixed position relative to each other. Together with the snap lips 27 driven by toothed wheel 13 and the toothed wheel 13, toothed wheel 20 is reciprocally slidable over positioning shaft 14, whereby it is either in contact with toothed wheel 21 for driving the translation chain 5, 6 or its non-round central socket 35 is in engagement with a shaft 36 of complementary form which forms the input shaft of planetary system 18, such that in the above described manner the non-round shaft 9 can be driven when the degree of freedom of rotation is active.

FIG. 12 shows the manner in which toothed wheel 20 is slidable reciprocally as according to an arrow 38 relative to toothed wheel 22. Support bracket 39 supports toothed wheel 20 rotatably and is fixedly connected to block 33. The unit of which toothed wheel 20 forms part is shown in FIG. 13. FIG. 12 shows that block 33 is slidable in a tube 40, this between two stable positions, as described above with reference to FIG. 13.

Planetary system 18 with the non-round output socket 17 is accommodated in a housing 37.

It is noted that the switching parts, which are alternately placed in and taken out of engagement with each other during a changeover from the one degree of freedom to the other, preferably have on the sides directed toward each other rounded or chamfered portions acting as positioning edges. These are the front edges of toothed wheels 20 and 21 and the front edge of the non-round protrusion 36 and the outer edge of the non-round socket 35.

Plastic frame parts 41, 42, 43 carry the above described components. In this way the diverse components are enclosed in the manner of a housing and protected from outside mechanical influences. When the above described components are assembled into a unit, a guard 44 can be arranged in snapping manner after the bead chain 12 has been trained over toothed wheel 13 through the eye of operating bracket 16.

FIG. 15 shows a variant in which two roller blinds 48, 49 can be individually operated by the central drive. In this embodiment the central drive is embodied such that toothed wheel 22 is coupled directly to a winding shaft (not shown).

1-11. (canceled)

12. A device for operating a screen, such as a window covering, which has at least two mutually independent degrees of freedom, which device has a central drive which can be switched between the degrees of freedom by means of switching means, which switching means can be operated by means of operating means,
wherein the switching means have a stable position for each degree of freedom,
wherein the central drive comprises a transmission with one input shaft and a number of output shafts, one for each degree of freedom,
wherein, the input shaft is coupled to the operating means driving the input shaft rotatingly in optionally the one or other direction,
wherein the switching means comprise a switching member which can be operated by the operating means and which, when operated, uncouples the input shaft from the output shaft to which it is at that moment coupled, and subsequently couples it to another output shaft; and
characterized in that, the input shaft is essentially in line with one of the output shafts.

13. A device as claimed in claim 12, wherein the switching means comprise rotatable pairs of components which are placed in mutual engagement or taken out of engagement during switching between the degrees of freedom, for instance toothed wheels which are axially displaceable relative to each other, wherein one rotatable component (20) is reciprocally slidable over the input shaft (14), whereby it is either in contact with a rotatable component (21) for driving a first output shaft (5, 6) or its non-round central socket (35) is in engagement with a second output shaft (9) being in line with the input shaft.

14. A device as claimed in claim 12, wherein the switching means comprise a toothed wheel (20) that is reciprocally slidable over a positioning shaft (14), whereby it is either in contact with a toothed wheel (21) for driving a translation chain (5, 6) or its non-round central socket (35) is in engagement with a shaft (36) of complementary form which forms the input shaft of a planetary system (18), such that a non-round shaft (9) can be driven when the degree of freedom of rotation is active.

15. A device as claimed in claim 12, wherein the device comprises a housing to which a second housing is releasably coupled, in which second housing the central housing and the switching means are accommodated.

16. A device as claimed in claim 12, wherein the switching means comprise rotatable pairs of components which are placed in mutual engagement or taken out of engagement during switching between the degrees of freedom, for instance toothed: wheels which are axially displaceable relative to each other, wherein the end edges first making contact with each other of at least one of a pair of these components has a chamfered, for instance non-round form, and thus have positioning edges.

17. A device as claimed in claim 12, wherein the screen comprises at least two part-screens, each having at least one degree of freedom, for instance a translatable roller blind and/or a pleated blind, and/or a folding blind.

18. A device as claimed in claim 12, wherein the operating means comprise a control cord which can be operated by hand, a rotation handle which can be operated by hand, or an electric motor.
